(19) United States
(12) Patent Application Publication
(10) Pub. No.: US 2003/0076823 A1
(43) Pub. Date: Apr. 24, 2003

(54) Nonblocking switching network

(76) Inventors: Franz Lindwurm, Muenchen (DE); Thomas Treyer, Muenchen (DE); Marcel-Abraham Troost, Muenchen (DE)

Correspondence Address: MORRISON & FOERSTER LLP, 1650 TYSONS BOULEVARD, SUITE 300, MCLEAN, VA, 22102, US

(21) Appl. No.: 10/149,587

(22) PCT Filed: Dec. 12, 2000
(86) PCT No.: PCT/DE00/04419

(30) Foreign Application Priority Data
Dec. 17, 1999 (DE) 199 61 150.5

(51) Int. Cl. H04Q 11/00

(52) U.S. Cl. 370/388; 370/386

(57) ABSTRACT

The invention relates to a nonblocking switching network, comprising a plurality of input/output terminals (LI0 to LI15) for connecting a plurality of line terminator groups (LTG) for a plurality of data channels (BO) to be switched; and a time/space switching network (ZRKN). An input/output stage has a concentrator network (KN) with a concentrator/demultiplexer device (KT) which condenses/divides the plurality of data channels (BO) to be switched in the switching network. Said time/space switching network (ZRKN) consists of at least one n/n switching matrix (KM). This results in a 100% nonblocking switching network which is flexible and can be expanded modularly.

### CLAIM FOR PRIORITY

This application claims priority to International Application No. PCT/DE00/04419 which was published in the German language on Jun. 21, 2001.

### TECHNICAL FIELD OF THE INVENTION

The present invention relates to a nonblocking switching network, and in particular, to a switching network which has one hundred per cent freedom from blocking and a modular expansion capability.

### BACKGROUND OF THE INVENTION

FIG. 1 shows a simplified block view of a telecommunications network according to the prior art, in which a switching network SN is used for an actual connection setup. Accordingly, a switching office has a central switching unit ZVE with the switching network SN, a signaling system network control SSNC (Signaling System Network Control) for processing signaling data and a coordination processor CP for controlling both the signaling system network control SSNC and the switching network SN. The coordination processor CP permits the central switching unit ZVE to be operated and maintained while the signaling system network control SSNC is connected to other switching offices or signaling nodes via, for example, CCSNo. 7—high speed channels of the central signaling system No. 7 (Common Channel Signaling System No. 7). In order to connect respective subscriber lines, the switching office has a multiplicity of line trunk groups LTG (Line/Trunk Group) which are, for example, connected to digital line units DLU or transfer CCSNo. 7 signaling data. According to FIG. 1, the actual subscriber terminals TE whose respective data channels are switched by the switching office in the form of voice information or data information are connected to the digital line units DLU.

As an alternative to connecting the subscriber terminals TE directly via the digital line units DLU, such a connection can also be made via remote switching units RSU, which are remote-controlled from the central switching office. Such a connection is generally made by means of what are referred to as remote-control interfaces HTI (Host Timeslot Interchange).

The actual switching or the physical connection of the data channels produced in the subscriber terminals TE takes place here in the switching network SN. FIG. 2 shows in this respect a simplified schematic block view in which the basic method of operation of a switching network according to the prior art is illustrated.

According to FIG. 2, such a conventional switching network is composed of a time switching network ZKN for chronologically assigning the data channels to be switched and a space switching network RKN for spatially assigning the data channels to be switched. The time switching network ZKN and the space switching network RKN are connected to one another here via switching lines KL. In order to switch a call, a data channel from, for example, a microphone of a subscriber A is accordingly assigned firstly by the input-end time switching network ZKN in a time slot assigned to a subscriber B and is fed to the space switching network RKN via the switching network lines KL. In the space switching network RKN there is now a spatial assignment of the already chronologically assigned data channels from the subscriber A to the subscriber B. Here, as it were, the physical assignment to the respective line trunk group LTG is carried out, as a result of which a connection is switched through, for example, from the microphone of the subscriber A to the loudspeaker of the subscriber B. In the opposite direction there is a similar switching through of a connection from the microphone of the subscriber B to the loudspeaker of the subscriber A. The input lines EL and the output lines AL preferably constitute here the connecting lines to the respective line trunk groups LTG.

FIG. 3 shows a part ZK of the time switching network ZKN in simplified form, the information transmitted in a time-division multiplex system (for example of the subscriber A in the timeslot 3) being stored in a data memory DS. A connection memory VS which is driven by the coordination processor CP actuates here a switching device SV in such a way that, for example, the information of the subscriber A which is stored in the timeslot 3 is assigned, as a function of the signaling information, to a timeslot 7 by means of which the subscriber B can be reached. In this way a chronological assignment in the time switching network ZKN is obtained.

In contrast, according to FIG. 4 a spatial assignment of the respective switching network lines KL to corresponding switching network lines KL′ is established in the part RK of the space switching network RKN. Such a space switching part RK is composed, for example, of a multiplicity of multiplexers RZ1 to RZ4 which can be actuated and to which a multiplicity of switching network lines KL1 to KL4 are connected. In turn, a spatial assignment or switching through to switching network lines KL1′ to KL4′ is carried out by means of a connection memory VS which is actuated by the coordination processor CP.

FIG. 5 shows a conventional 4/4 switching matrix KM with a multiplicity of space switching parts RK (x/y) for connecting the respective incoming switching network lines KL to the outgoing switching network lines KL′. However, a disadvantage with such conventional switching matrices KM is the extraordinarily high number of switching points which are implemented by the space switching parts RK (x/y). As such switching matrices are extremely expensive to implement and moreover require only 25 per cent for the actual implementation of the spatial switching, they have been removed from what are referred to as Clos groupings, which is illustrated in simplified form in FIG. 6.

The Clos grouping illustrated in FIG. 6 has, in contrast with the n/n switching matrix KM according to FIG. 5, the significant advantage that a significantly higher number of links can be implemented using a significantly lower number of switching points. This is carried out in particular by means of an n/2n−1 assignment with combined path search, as a result of which virtually nonblocking switching matrices are also obtained. However, as the newly switched connections are implemented as a function of already switched connection, there is no absolute freedom from blocking and a probability—even if very small—of blocking when there is a very high traffic volume.

However, owing to current trends, increasing numbers of people require communication, for which reason the connection volume is continuing to rise and increasing the probability of the switching network blocking.

Moreover, the operators (service providers) of telecommunications networks have an interest in reducing the number of switching offices in order to reduce the operating costs. Network consolidation can entail the elimination of network hierarchies, but also results in centralization of the intelligence or control in a smaller number of switching nodes, for which greater use of large and remote switching units with the full range of performance and features becomes necessary.

Finally, the service providers which are newly penetrating the telecommunications market are attempting from the outset, motivated by the reduction of costs, to operate using, for example, only one central switching office with a large number of remote switching units.

### SUMMARY OF THE INVENTION

The invention provides a switching network which is nonblocking and has flexibility in the implementation of a wide variety of switching requirements. In particular, linear expansion is possible without rearranging the switching network, resulting in a reduced number of switching offices via replacement by means of remote units.

In one embodiment of the invention, a concentrator unit with a concentrator device compresses the number of data channels to be switched on switching network lines in the switching network, and a time/space switching network which includes at least one n/n switching matrix, a nonblocking switching network is obtained which implements an increased connection volume without difficulty and moreover can be expanded in a flexible way.

In another aspect of the invention, a relatively small connection volume is implemented. The concentrator network includes 0.5×n concentrator units, and the time/space switching network includes an n/n switching matrix in which half of the switching points are used and actuated.

In another aspect of the invention, a relatively large connection volume is implemented. The concentrator network can includes, for example, n concentrator units and the time/space switching network can have two n/n switching matrices which are connected to one another, the one switching matrix being fixedly connected and the other being actuated by the coordination processor.

In still another aspect of the invention, an extremely high connection volume is implemented. The concentrator network includes a×n concentrator units, and the time/space switching network includes a n/n switching matrices and a special switching matrix, which are connected to one another, the switching matrices being fixedly connected and the special switching matrix being actuated by the coordination processor.

In another embodiment, in order to improve the modularity of—the nonblocking switching network further, the switching network lines which are present in the switching network can be implemented by means of optical and/or high-frequency electrical interfaces, greatly reducing the space required and the susceptibility to faults.

The concentrator device preferably has a channel multiplexer unit for compressing a multiplicity of data channels in the time-division multiplex system transmitted by the switching network lines. In order to protect and monitor a series of data channels which are to be switched, inter-channel protection data can be introduced here by the channel multiplexer unit. In this way, an incorrect transmission or a fault within the switching network is monitored and signaled during the operation.

Moreover, the concentrator device can have a channel expansion unit for expanding the multiplicity of data channels to be switched, channel-specific protection data being introduced. In this way, respective data channels can be monitored and protected individually, in particular when implementing dedicated lines.

### BRIEF DESCRIPTION OF THE DRAWINGS

The invention is described below in more detail by means of exemplary embodiments and with reference to the drawings, in which:

FIG. 1 shows a simplified block view of a telecommunications network according to the prior art.

FIG. 2 shows a simplified view of a switching matrix according to the prior art.

FIG. 3 shows a simplified view of part of the conventional time switching network.

FIG. 4 shows a simplified view of part of the conventional space switching network.

FIG. 5 shows a schematic view of a 4/4 switching matrix according to the prior art.

FIG. 6 shows a simplified view of a Clos grouping according to the prior art.

FIG. 7 shows a simplified block view of the inventive switching network according to a first exemplary embodiment.

FIG. 8 shows a simplified block view of a time/space switching network of the inventive switching network according a second exemplary embodiment.

FIG. 9 shows a simplified block view of a time/space switching network of the inventive switching network according to a third exemplary embodiment.

FIG. 10 shows a simplified block view of a concentrator device such as is used in the switching networks according to the first to third exemplary embodiments.

### DETAILED DESCRIPTION OF THE PREFERRED EMBODIMENTS

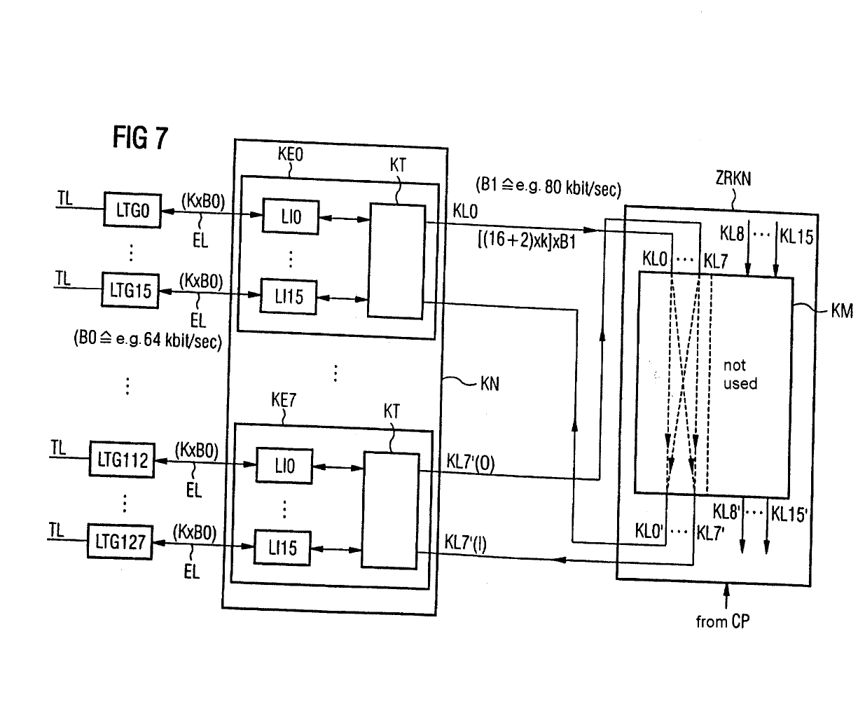

FIG. 7 shows a simplified block diagram of a nonblocking switching network according to a first exemplary embodiment, identical reference symbols designating identical or similar elements to the prior art.

The switching network according to FIG. 7 includes a concentrator network KN and a time/space switching network ZRKN, which are connected to one another via switching network lines KL. The concentrator network KN has, for example, eight concentrator units KE0 to KE7, which each have 16 input/output terminals LI0 to LI15. The input/output terminals LI0 to LI15 are used to connect the switching network to line trunk groups LTG0 to LTG 127, which are in turn connected to corresponding subscribers by means of a multiplicity of subscriber lines TL.

Each line trunk group LTG0 to LTG 127 usually has k=128 data channels B0, which are fed via an input line EL to the respective input/output terminals LI0 to LI15 of the respective concentrator units KE0 to KE7. With a typical data width of 64 kbit/s for a data channel B0 which is to be switched, a transmission rate of 8.192 Mbit/s is thus obtained for the respective input lines EL.

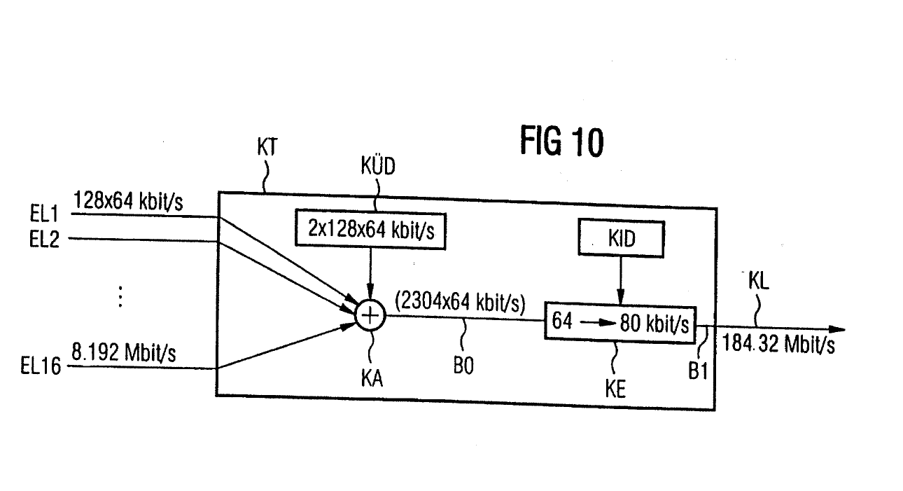

These data channels B0 which are to be switched k (=128) times are now transmitted via the input/output terminals LI0 to LI15, which essentially comprise a physical interface, to a concentrator unit KT which compresses the multiplicity of data channels k×B0 to be switched on switching network lines KL0 to KL7. In order to clarify the method of operation of the concentrator device KT, reference is made below to FIG. 10.

The concentrator device KT preferably includes, according to FIG. 10, of a channel multiplexer unit KA, which combines the k (=128) data channels B0 (64 kbit/s) to be switched which are fed by the input/output terminals LI0 to LI15 and are to be switched, resulting in a data transmission rate of, for example, 16×128×64 kbit/s.

Moreover, according to FIG. 10 inter-channel protection data KÜD in the form of 2×128 data channels (2×128×64 kbit/s) can be added to the compressed data stream by the channel multiplexer unit KA, resulting in a compressed transmission rate of 2048+256=2304 data channels (65 kbit/s). The additionally inserted inter-channel protection data KÜD is used here in particular to protect and/or monitor a series of the data channels B0 to be switched.

In addition, in order to provide further protection and/or monitoring of the data transmitted on the switching network lines KL, it is possible, according to FIG. 10, to provide a channel expansion unit KE in the concentrator device KT, said channel expansion unit KE permitting the multiplicity of data channels B0 to be expanded into a multiplicity of expanded data channels B1. For this purpose, for example each data channel B0 which is to be switched is expanded with channel-specific protection data KID, as a result of which the expanded data channels B1 are obtained. The data channels which are to be switched with their data rate of 64 kbit/s are preferably expanded to expanded data channels with a data rate of 80 kbit/s. The channel-specific protection data KID is used here to protect and/or monitor each individual data channel and comprises, for example, a parity check and other monitoring functions, as a result of which each individual data channel B0 or expanded data channel B1 to be switched can be monitored and protected. In particular, when dedicated lines are set up, this provides the possibility of online monitoring of transparent switched-through connecting lines, in which case a connection termination or some other fault which occurs can be detected immediately and eliminated.

In conjunction with a demultiplexer device which is not described in more detail below or illustrated it is possible to detect and signal at any time a faulty transmission of data channels by evaluating the intra-channel protection data KÜD within the switching network SN, permitting a fault which occurs in the compressed data stream to be detected at any time and/or corrected or eliminated automatically. The demultiplexer device has essentially an identical structure to that of the concentrator device KT, but a channel minimizing unit returns the expanded data stream to, for example, 64 kbit/s and a channel demultiplexer unit divides the compressed data stream into, for example, 16×128 data channels again. The high frequency data streams which are produced by the concentrator device KT can thus be used and transmitted without difficulty within the switching network SN.

The data stream which is compressed by the concentrator device KT consequently has a data rate of 184.32 Mbit/s to be transmitted on the switching network lines KL0 to KL7, given a customary data rate of 128 data channels per line trunk group LTG and a data rate of 64 kbit/s for each data channel B0, intra-channel protection data KÜD and channel-specific protection data KID being included. Both the channel-specific protection data and the intra-channel protection data can be used here as synchronization data in the switching network SN.

Returning again to FIG. 7, the further method of operation of the switching network according to the invention will be described below. The data channels which are compressed in this way by the concentrator device KT (and already chronologically assigned) are now transmitted via the switching network lines KL0 to KL7 to the time/space switching network ZRKN with its switching matrix KM located in it. In the switching network illustrated in FIG. 7 with its eight concentrator units KE0 to KE7, eight switching network lines KL0 to KL7 are consequently fed to the eight input lines of the switching matrix KM, while the eight associated output lines KL0′ to KL7′ of the switching matrix KM are fed back again to the respective concentrator devices KT.

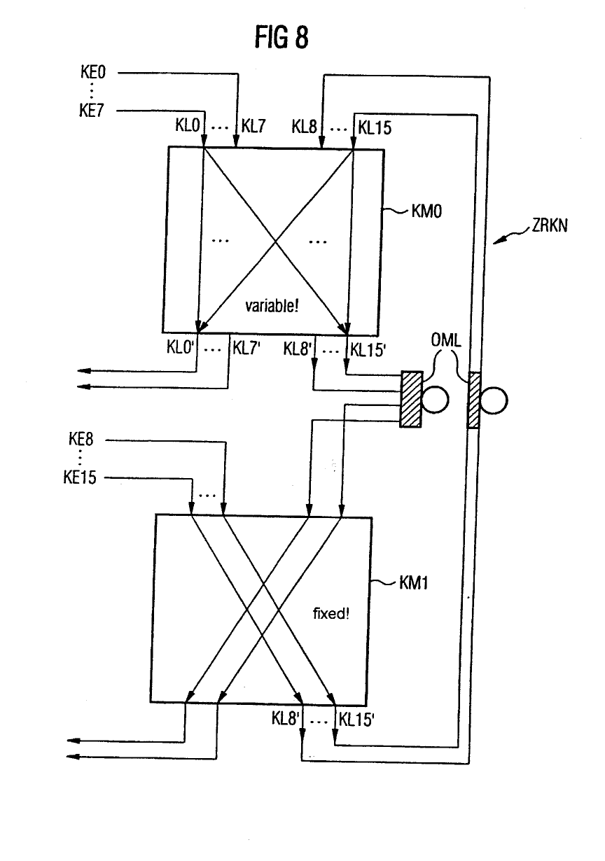

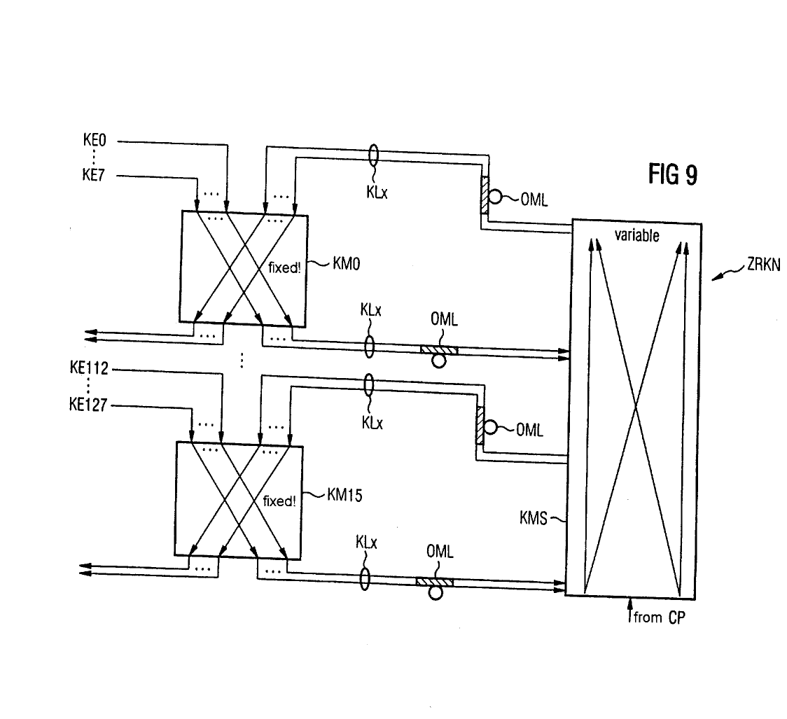

In contrast to the conventionally used switching matrices, which have Clos groupings owing to the improved effectiveness, the present invention uses an n/n switching matrix or, according to FIG. 7, a 16/16 switching matrix. In the first exemplary embodiment illustrated in FIG. 7 it is to be noted that merely a quarter of the switching matrix KM (terminals 0 to 7) is used and actuated by the coordination processor CP, while the remaining three quarters of the switching matrix KM (terminals 8 to 15) are not used. Such a structure has a significant advantage, in particular when implementing switching networks with a relatively high capacity, because the time/space switching networks or the associated switching matrices KM can be used in a modular fashion, as is described below with reference to FIG. 8.

FIG. 8 shows a simplified view of a time/space switching matrix ZRKN in a switching network according to a second exemplary embodiment, which can be used for example for switching offices of medium capacity. In contrast to the switching network structure illustrated in FIG. 7 in accordance with the first exemplary embodiment, up to 16 concentrator units KE0 to KE15 are connected to the time/space switching network ZRKN according to FIG. 8, resulting in a doubling of the capacity for the data channels to be switched. In particular, use of the switching matrix KM which is to be used in modular fashion now has an advantageous effect. To be more precise, a time/space switching network which is to be implemented is implemented from two switching matrices KM0 and KM1 which have identical structures and are composed again from 16/16 switching matrices according to FIG. 8.

However, in order to implement the increased connection capacity, the switching matrix KM1 is now fixedly connected, i.e. the inputs of the first eight terminals are switched to the outputs of the second eight outputs, and the inputs of the second eight terminals are switched to the outputs of the first eight terminals. Furthermore, the second eight terminals of the output of the switching matrix KM1 are connected to the second eight input terminals of the switching matrix KM0. In the same way, the second eight output terminals of the switching matrix KM0 are connected to the second eight input terminals of the switching matrix KM1, resulting in a fully interconnected switching matrix. In order to establish the respective connections, merely the switching matrix KM0 is actuated by the coordination processor, both the first and second halves of the switching points of the switching matrix KM0 being used. In this way, a respective capacity of the switching matrix can be changed in an extremely flexible, cost-effective and finely grained way using a switching matrix module KM.

In particular, with the modular implementation of the switching matrices KM0 and KM1, the structure for the time/space switching matrix is simplified significantly if entirely or partially optical interfaces OML are used for the switching network lines. Such optical interfaces OML can bring about a further concentration of the data channels to be transmitted, preferably the 8×184.32 Mbit/s data streams being converted into 2×921.6 Mbit/s optical data transmission streams.

However, instead of the optical interfaces it is also possible to implement electrical interfaces such as, for example, waveguides, coaxial cables and comparable interfaces with extremely high data rates.

FIG. 9 shows a simplified view of a time/space switching network ZRKN in a switching network according to a third exemplary embodiment, it being possible to connect a maximum number of subscriber lines or connecting lines.

In contrast to the first and second exemplary embodiments according to FIGS. 7 and 8, in the exemplary embodiment according to FIG. 9 up to 128 concentrator units KE 0 to KE 127 with their associated 16 line trunk groups LTG0 to LTG15 can be connected, as a result of which, given a customary channel width of 128 channels per line trunk group LTG, over 1,000,000 subscriber lines or 240,000 connecting lines can be connected and linked.

The time/space switching network according to FIG. 9 includes 16 uniformly structured switching matrices KM0 to KM15 which correspond essentially to the switching matrices according to the first and second exemplary embodiments. The first half of the respective input terminals is connected here to the associated concentrator units and fixedly linked to the second half of the output terminals via the switching matrix. In addition, the first output terminals of the switching matrix KM are connected to the associated concentrator unit and fixedly connected to the second half of the input terminals of the switching matrix via the switching matrix KM. The switching matrices KM0 to KM15 are consequently fixedly linked internally and are not actuated by the coordination processor CP.

The actual linking rather takes place here in a special switching matrix KMS, which has, for example, a size of 128/128 according to FIG. 9. The switching matrices KM0 to KM15 are connected here via switching network lines KLx to the special switching matrix KMS in such a way that each of the connected concentrator units KE0 to KE127 can be connected or linked to every other one. The special switching matrix KMS is implemented here again from a multiplicity of specially arranged switching matrices of the type described above.

In this way, a switching network is obtained which is one hundred per cent blocking free owing to the n/n switching matrices used, and has an extremely high number of switching processes owing to the compression of the data channels to be switched which is used.

In the implementation of the inventive switching network described above, the use of optical interfaces was proposed merely within the switching network. However, the invention is not restricted to this and rather also comprises optical interfaces in the direction of the line trunk groups LTG. In particular when implementing the special switching matrix KMS as a 128/128 switching matrix, the necessity to implement optical interfaces between various levels is dispensed with as it is possible to implement a distribution of switching network lines as what is referred to as back panel wiring. By eliminating the optical interfaces between various levels, both the costs and the frequency of faults are reduced in comparison with the prior art.

In particular in the technical implementation of the switching network described above, a flexible expansion capability of the switching network, which can also be adapted in a finely grained way, is obtained without changing existing cabling or interfaces owing to the modular design. In particular, when the switching network is used in the Siemens EWSD switching system, the components which are to be expanded can easily be added in order to expand the capacity.

In particular when a concentration from 16×8.192 Mbit/s to 184.32 Mbit/s is selected, in addition to the data useful channels which are to be switched in the line trunk groups LTG there are additionally available 2×128 data channels per 125 microsecond time frame for synchronization, online testing and further routine tests. Here, the 8 bits of each data useful channel to be switched are expanded with 2 parity bits In this way, falsifications in the data stream of the switching network can be detected and localized without the influence of the control in the switching system (cross office check). In particular when using a 184.32 Mbit/s signal, a sufficient basis is thus available for all monitoring and testing scenarios in the switching network.

In addition, owing to the concentration by the concentrator device, the number of cables to be laid (switching network lines) is reduced, for example, to 1/16 with respect to the input lines EL (with 8.192 Mbit/s).

In order to reduce further the amount of space required, the switching matrices or partial switching matrices described above are preferably embodied as ASICs.

### Description

### Nonblocking Switching Network

The present invention relates to a nonblocking switching network and in particular to a switching network and in particular to a switching network which has one hundred per cent freedom from blocking and a modular expansion capability.

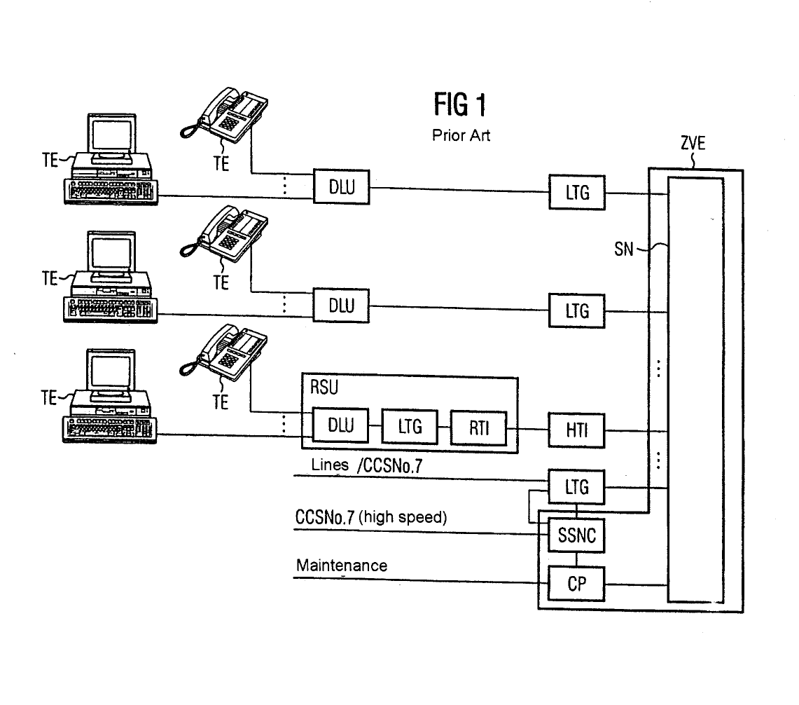

FIG. 1 shows a simplified block view of a telecommunications network according to the prior art, in which a switching network SN is used for an actual connection setup. Accordingly, a switching office has a central switching unit ZVE with the switching network SN, a signaling system network control SSNC (Signaling System Network Control) for processing signaling data and a coordination processor CP for controlling both the signaling system network control SSNC and the switching network SN. The coordination processor CP permits the central switching unit ZVE to be operated and maintained while the signaling system network control SSNC is connected to other switching offices or signaling nodes via, for example, CCSNo. 7—high speed channels of the central signaling system No. 7 (Common Channel Signaling System No. 7). In order to connect respective subscriber lines, the switching office has a multiplicity of line trunk groups LTG (Line/Trunk Group) which are, for example, connected to digital line units DLU or transfer CCSNo. 7 signaling data. According to FIG. 1, the actual subscriber terminals TE whose respective data channels are switched by the switching office in the form of voice information or data information are connected to the digital line units DLU.

As an alternative to connecting the subscriber terminals TE directly via the digital line units DLU, such a connection can also be made via remote switching units RSU, which are remote-controlled from the central switching office. Such a connection is generally made by means of what are referred to as remote-control interfaces HTI (Host Timeslot Interchange).

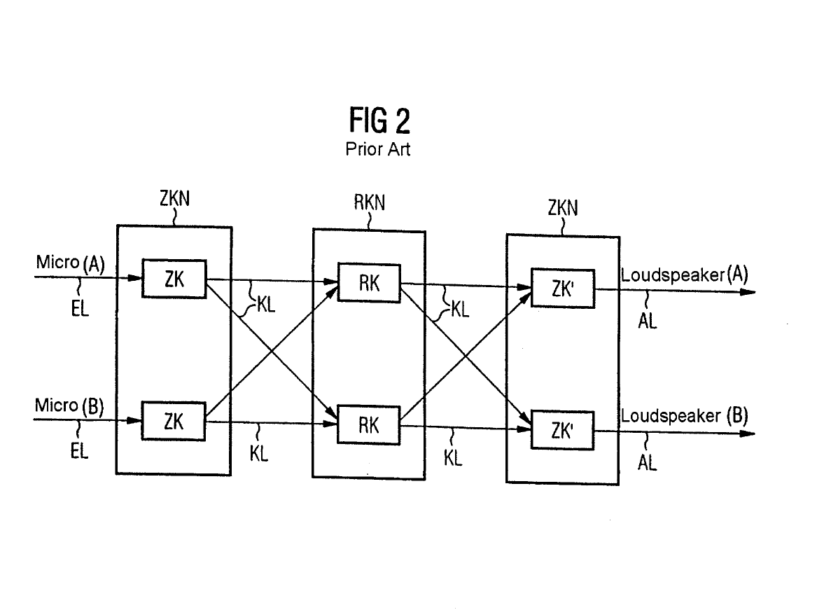

The actual switching or the physical connection of the data channels produced in the subscriber terminals TE takes place here in the switching network SN. FIG. 2 shows in this respect a simplified schematic block view in which the basic method of operation of a switching network according to the prior art is illustrated.

According to FIG. 2, such a conventional switching network is composed of a time switching network ZKN for chronologically assigning the data channels to be switched and a space switching network RKN for spatially assigning the data channels to be switched. The time switching network ZKN and the space switching network RKN are connected to one another here via switching lines KL. In order to switch a call, a data channel from, for example, a microphone of a subscriber A is accordingly assigned firstly by the input-end time switching network ZKN in a time slot assigned to a subscriber B and is fed to the space switching network RKN via the switching network lines KL. In the space switching network RKN there is now a spatial assignment of the already chronologically assigned data channels from the subscriber A to the subscriber B. Here, as it were, the physical assignment to the respective line trunk group LTG is carried out, as a result of which a connection is switched through, for example, from the microphone of the subscriber A to the loudspeaker of the subscriber B. In the opposite direction there is a similar switching through of a connection from the microphone of the subscriber B to the loudspeaker of the subscriber A. The input lines EL and the output lines AL preferably constitute here the connecting lines to the respective line trunk groups LTG.

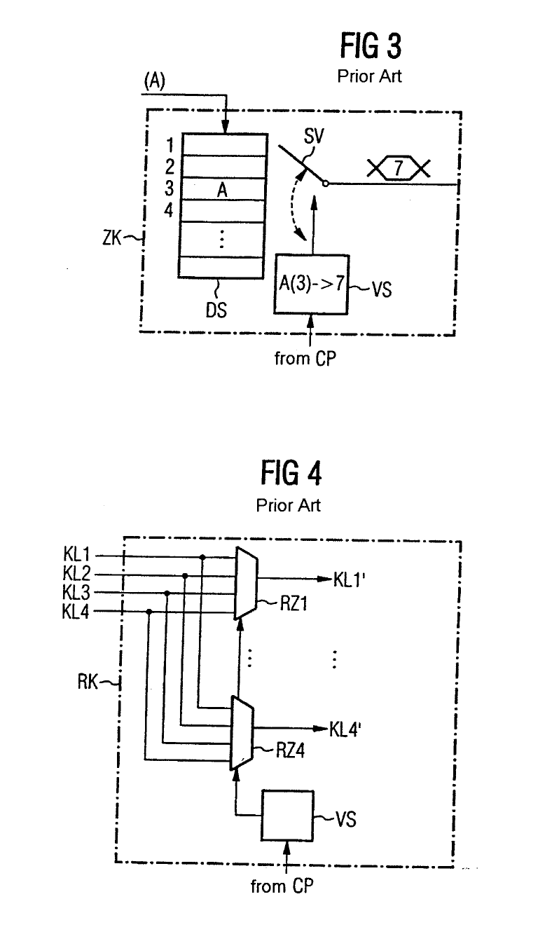

FIG. 3 shows a part ZK of the time switching network ZKN in simplified form, the information transmitted in a time-division multiplex system (for example of the subscriber A in the timeslot 3) being stored in a data memory DS. A connection memory VS which is driven by the coordination processor CP actuates here a switching device SV in such a way that, for example, the information of the subscriber A which is stored in the timeslot 3 is assigned, as a function of the signaling information, to a timeslot 7 by means of which the subscriber B can be reached. In this way a chronological assignment in the time switching network ZKN is obtained.

In contrast, according to FIG. 4 a spatial assignment of the respective switching network lines KL to corresponding switching network lines KL′ is established in the part RK of the space switching network RKN. Such a space switching part RK is composed, for example, of a multiplicity of multiplexers RZ1 to RZ4 which can be actuated and to which a multiplicity of switching network lines KL1 to KL4 are connected. In turn, a spatial assignment or switching through to switching network lines KL1′ to KL4′ is carried out by means of a connection memory VS which is actuated by the coordination processor CP.

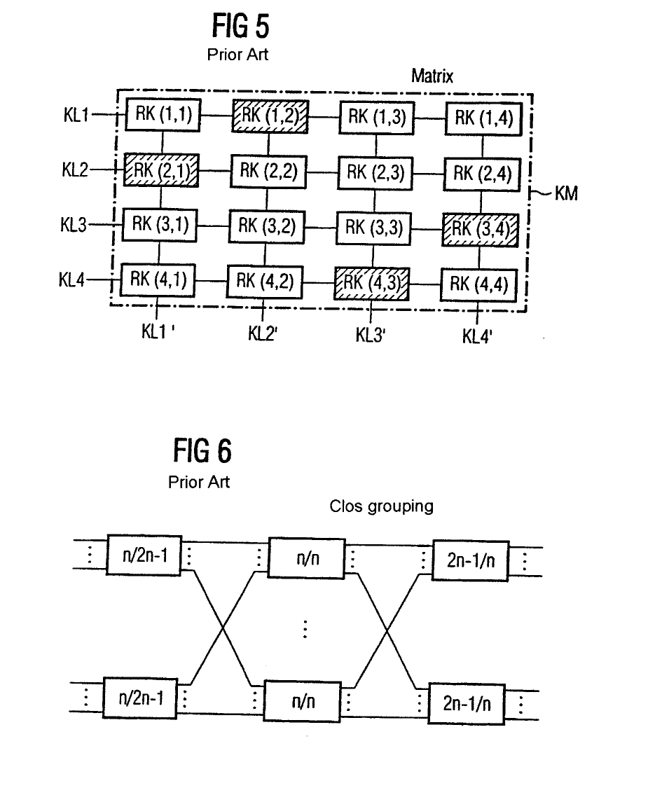

FIG. 5 shows a conventional 4/4 switching matrix KM with a multiplicity of space switching parts RK (x/y) for connecting the respective incoming switching network lines KL to the outgoing switching network lines KL′. However, a disadvantage with such conventional switching matrices KM is the extraordinarily high number of switching points which are implemented by the space switching parts RK (x/y). As such switching matrices are extremely expensive to implement and moreover require only 25 per cent for the actual implementation of the spatial switching, they have been removed from what are referred to as Clos groupings, which is illustrated in simplified form in FIG. 6.

The Clos grouping illustrated in FIG. 6 has, in contrast with the n/n switching matrix KM according to FIG. 5, the significant advantage that a significantly higher number of links can be implemented using a significantly lower number of switching points. This is carried out in particular by means of an n/2n−1 assignment with combined path search, as a result of which virtually nonblocking switching matrices are also obtained. However, as the newly switched connections are implemented as a function of already switched connection, there is no absolute freedom from blocking and a probability—even if very small—of blocking when there is a very high traffic volume.

However, owing to current trends, increasing numbers of people require communication, for which reason the connection volume is continuing to rise and increasing the probability of the switching network blocking.

Moreover, the operators (service providers) of telecommunications networks have an interest in reducing the number of switching offices in order to reduce the operating costs. What is referred to as network consolidation can entail the elimination of network hierarchies, but also results in centralization of the intelligence or control in a smaller number of switching nodes, for which greater use of large and remote switching units with the full range of performance and features becomes necessary.

Finally, the service providers which are newly penetrating the telecommunications market are attempting from the outset, motivated by the reduction of costs, to operate using, for example, only one central switching office with a large number of remote switching units.

The invention is therefore based on the object of providing a switching network which is 100% nonblocking and has extremely high flexibility in the implementation of a wide variety of switching requirements. In particular, the intention is to make possible a linear expansion capability without rearranging the switching network, it being possible to reduce the number of switching offices via replacement by means of remote units.

This object is achieved according to the invention by means of the characterizing features of patent claim 1.

In particular through the use of a concentrator unit with a concentrator device which compresses the number of data channels to be switched on switching network lines in the switching network, and a time/space switching network which is composed of at least one n/n switching matrix, a 100% nonblocking switching network is obtained which implements an increased connection volume without difficulty and moreover can be expanded in a flexible way.

In order to implement a relatively small connection volume, the concentrator network is composed merely of 0.5×n concentrator units, and the time/space switching network is composed of an n/n switching matrix in which only half of the switching points are used and actuated.

In order to implement a relatively large connection volume, the concentrator network can be composed of n concentrator units and the time/space switching network can have two n/n switching matrices which are connected to one another, the one switching matrix being fixedly connected and the other being actuated by the coordination processor.

In order to implement an extremely high connection volume, the concentrator network is composed of a×n concentrator units, and the time/space switching network is composed of a n/n switching matrices and a special switching matrix, which are connected to one another, the switching matrices being fixedly connected and only the special switching matrix being actuated by the coordination processor.

In order to improve the modularity of the nonblocking switching network further, the switching network lines which are present in the switching network can be implemented by means of optical and/or high-frequency electrical interfaces, greatly reducing the space required and the susceptibility to faults.

The concentrator device preferably has a channel multiplexer unit for compressing a multiplicity of data channels in the time-division multiplex system transmitted by the switching network lines. In order to protect and monitor a series of data channels which are to be switched, inter-channel protection data can be introduced here by the channel multiplexer unit. In this way, an incorrect transmission or a fault within the switching network is monitored and signaled during the operation.

Moreover, the concentrator device can have a channel expansion unit for expanding the multiplicity of data channels to be switched, channel-specific protection data being introduced. In this way, respective data channels can be monitored and protected individually, in particular when implementing dedicated lines.

The invention is described below in more detail by means of exemplary embodiments and with reference to the drawing, in which:

FIG. 1 shows a simplified block view of a telecommunications network according to the prior art;

FIG. 2 shows a simplified view of a switching matrix according to the prior art;

FIG. 3 shows a simplified view of part of the conventional time switching network;

FIG. 4 shows a simplified view of part of the conventional space switching network;

FIG. 5 shows a schematic view of a 4/4 switching matrix according to the prior art;

FIG. 6 shows a simplified view of a Clos grouping according to the prior art;

FIG. 7 shows a simplified block view of the inventive switching network according to a first exemplary embodiment;

FIG. 8 shows a simplified block view of a time/space switching network of the inventive switching network according a second exemplary embodiment;

FIG. 9 shows a simplified block view of a time/space switching network of the inventive switching network according to a third exemplary embodiment; and

FIG. 10 shows a simplified block view of a concentrator device such as is used in the switching networks according to the first to third exemplary embodiments.

FIG. 7 shows a simplified block diagram of a nonblocking switching network according to a first inventive exemplary embodiment, identical reference symbols designating identical or similar elements to the prior art.

The switching network according to FIG. 7 is composed essentially of a concentrator network KN and a time/space switching network ZRKN, which are connected to one another via switching network lines KL. The concentrator network KN has, for example, eight concentrator units KE0 to KE7, which each have 16 input/output terminals LI0 to LI15. The input/output terminals LI0 to LI15 are used to connect the switching network to line trunk groups LTG0 to LTG 127, which are in turn connected to corresponding subscribers by means of a multiplicity of subscriber lines TL.

Each line trunk group LTG0 to LTG 127 usually has k=128 data channels B0, which are fed via an input line EL to the respective input/output terminals LI0 to LI15 of the respective concentrator units KE0 to KE7. With a typical data width of 64 kbit/s for a data channel B0 which is to be switched, a transmission rate of 8.192 Mbit/s is thus obtained for the respective input lines EL.

These data channels B0 which are to be switched k (=128) times are now transmitted via the input/output terminals LI0 to LI15, which essentially constitute a physical interface, to a concentrator unit KT which compresses the multiplicity of data channels k×B0 to be switched on switching network lines KL0 to KL7. In order to clarify the method of operation of the concentrator device KT, reference is made below to FIG. 10.

The concentrator device KT is preferably composed, according to FIG. 10, of a channel multiplexer unit KA, which combines the k (=128) data channels B0 (64 kbit/s) to be switched which are fed by the input/output terminals LI0 to LI15 and are to be switched, resulting in a data transmission rate of, for example, 16×128×64 kbit/s.

Moreover, according to FIG. 10 inter-channel protection data KÜD in the form of 2×128 data channels (2×128×64 kbit/s) can be added to the compressed data stream by the channel multiplexer unit KA, resulting in a compressed transmission rate of 2048+256=2304 data channels (65 kbit/s). The additionally inserted inter-channel protection data KÜD is used here in particular to protect and/or monitor a series of the data channels B0 to be switched.

In addition, in order to provide further protection and/or monitoring of the data transmitted on the switching network lines KL, it is possible, according to FIG. 10, to provide a channel expansion unit KE in the concentrator device KT, said channel expansion unit KE permitting the multiplicity of data channels B0 to be expanded into a multiplicity of expanded data channels B1. For this purpose, for example each data channel B0 which is to be switched is expanded with channel-specific protection data KID, as a result of which the expanded data channels B1 are obtained. The data channels which are to be switched with their data rate of 64 kbit/s are preferably expanded to expanded data channels with a data rate of 80 kbit/s. The channel-specific protection data KID is used here to protect and/or monitor each individual data channel and comprises, for example, a parity check and other monitoring functions, as a result of which each individual data channel B0 or expanded data channel B1 to be switched can be monitored and protected.

In particular, when what are referred to as dedicated lines are set up, this provides the possibility of online monitoring of transparent switched-through connecting lines, in which case a connection termination or some other fault which occurs can be detected immediately and eliminated.

In conjunction with a demultiplexer device which is not described in more detail below or illustrated it is possible to detect and signal at any time a faulty transmission of data channels by evaluating the intra-channel protection data KÜD within the switching network SN, permitting a fault which occurs in the compressed data stream to be detected at any time and/or corrected or eliminated automatically. The demultiplexer device has essentially an identical structure to that of the concentrator device KT, but a channel minimizing unit returns the expanded data stream to, for example, 64 kbit/s and a channel demultiplexer unit divides the compressed data stream into, for example, 16×128 data channels again. The high frequency data streams which are produced by the concentrator device KT can thus be used and transmitted without difficulty within the switching network SN.

The data stream which is compressed by the concentrator device KT consequently has a data rate of 184.32 Mbit/s to be transmitted on the switching network lines KL0 to KL7, given a customary data rate of 128 data channels per line trunk group LTG and a data rate of 64 kbit/s for each data channel B0, intra-channel protection data KÜD and channel-specific protection data KID being included. Both the channel-specific protection data and the intra-channel protection data can be used here as synchronization data in the switching network SN.

Returning again to FIG. 7, the further method of operation of the switching network according to the invention will be described below. The data channels which are compressed in this way by the concentrator device KT (and already chronologically assigned) are now transmitted via the switching network lines KL0 to KL7 to the time/space switching network ZRKN with its switching matrix KM located in it. In the switching network illustrated in FIG. 7 with its eight concentrator units KE0 to KE7, eight switching network lines KL0 to KL7 are consequently fed to the eight input lines of the switching matrix KM, while the eight associated output lines KL0′ to KL7′ of the switching matrix KM are fed back again to the respective concentrator devices KT.

In contrast to the conventionally used switching matrices, which have Clos groupings owing to the improved effectiveness, the present invention uses an n/n switching matrix or, according to FIG. 7, a 16/16 switching matrix. In the first exemplary embodiment illustrated in FIG. 7 it is to be noted that merely a quarter of the switching matrix KM (terminals 0 to 7) is used and actuated by the coordination processor CP, while the remaining three quarters of the switching matrix KM (terminals 8 to 15) are not used. Such a structure has a significant advantage, in particular when implementing switching networks with a relatively high capacity, because the time/space switching networks or the associated switching matrices KM can be used in a modular fashion, as is described below with reference to FIG. 8.

FIG. 8 shows a simplified view of a time/space switching matrix ZRKN in a switching network according to a second exemplary embodiment, which can be used for example for switching offices of medium capacity. In contrast to the switching network structure illustrated in FIG. 7 in accordance with the first exemplary embodiment, up to 16 concentrator units KE0 to KE15 are connected to the time/space switching network ZRKN according to FIG. 8, resulting in a doubling of the capacity for the data channels to be switched. In particular, use of the switching matrix KM which is to be used in modular fashion now has an advantageous effect. To be more precise, a time/space switching network which is to be implemented is implemented from two switching matrices KM0 and KM1 which have identical structures and are composed again from 16/16 switching matrices according to FIG. 8.

However, in order to implement the increased connection capacity, the switching matrix KM1 is now fixedly connected, i.e. the inputs of the first eight terminals are switched to the outputs of the second eight outputs, and the inputs of the second eight terminals are to switched to the outputs of the first eight terminals. Furthermore, the second eight terminals of the output of the switching matrix KM1 are connected to the second eight input terminals of the switching matrix KM0. In the same way, the second eight output terminals of the switching matrix KM0 are connected to the second eight input terminals of the switching matrix KM1, resulting in a fully interconnected switching matrix. In order to establish the respective connections, merely the switching matrix KM0 is now actuated by the coordination processor, both the first and second halves of the switching points of the switching matrix KM0 being used. In this way, a respective capacity of the switching matrix can be changed in an extremely flexible, cost-effective and finely grained way using a switching matrix module KM.

In particular, with the modular implementation of the switching matrices KM0 and KM1, the structure for the time/space switching matrix is simplified significantly if entirely or partially optical interfaces OML are used for the switching network lines. Such optical interfaces OML can bring about a further concentration of the data channels to be transmitted, preferably the 8×184.32 Mbit/s data streams being converted into 2×921.6 Mbit/s optical data transmission streams.

However, instead of the optical interfaces it is also possible to implement electrical interfaces such as, for example, waveguides, coaxial cables and comparable interfaces with extremely high data rates.

FIG. 9 shows a simplified view of a time/space switching network ZRKN in a switching network according to a third exemplary embodiment, it being possible to connect a maximum number of subscriber lines or connecting lines.

In contrast to the first and second exemplary embodiments according to FIGS. 7 and 8, in the exemplary embodiment according to FIG. 9 up to 128 concentrator units KE 0 to KE 127 with their associated 16 line trunk groups LTG0 to LTG15 can be connected, as a result of which, given a customary channel width of 128 channels per line trunk group LTG, over 1,000,000 subscriber lines or 240,000 connecting lines can be connected and linked.

The time/space switching network according to FIG. 9 is now composed of 16 uniformly structured switching matrices KM0 to KM15 which correspond essentially to the switching matrices according to the first and second exemplary embodiments. The first half of the respective input terminals is connected here to the associated concentrator units and fixedly linked to the second half of the output terminals via the switching matrix. In addition, the first output terminals of the switching matrix KM are connected to the associated concentrator unit and fixedly connected to the second half of the input terminals of the switching matrix via the switching matrix KM. The switching matrices KM0 to KM15 are consequently fixedly linked internally and are not actuated by the coordination processor CP.

The actual linking rather takes place here in a special switching matrix KMS, which has, for example, a size of 128/128 according to FIG. 9. The switching matrices KM0 to KM15 are connected here via switching network lines KLx to the special switching matrix KMS in such a way that each of the connected concentrator units KE0 to KE127 can be connected or linked to every other one. The special switching matrix KMS is implemented here again from a multiplicity of specially arranged switching matrices of the type described above.

In this way, a switching network is obtained which is one hundred per cent blocking free owing to the n/n switching matrices used, and has an extremely high number of switching processes owing to the compression of the data channels to be switched which is used.

In the implementation of the inventive switching network described above, the use of optical interfaces was proposed merely within the switching network. However, the invention is not restricted to this and rather also comprises optical interfaces in the direction of the line trunk groups LTG. In particular when implementing the special switching matrix KMS as a 128/128 switching matrix, the necessity to implement optical interfaces between various levels is dispensed with as it is possible to implement a distribution of switching network lines as what is referred to as back panel wiring. By eliminating the optical interfaces between various levels, both the costs and the frequency of faults are reduced in comparison with the prior art.

In particular in the technical implementation of the switching network described above, a flexible expansion capability of the switching network, which can also be adapted in a finely grained way, is obtained without changing existing cabling or interfaces owing to the modular design. In particular, when the switching network is used in the Siemens EWSD switching system, the components which are to be expanded can easily be added in order to expand the capacity.

In particular when a concentration from 16×8.192 Mbit/s to 184.32 Mbit/s is selected, in addition to the data useful channels which are to be switched in the line trunk groups LTG there are additionally available 2×128 data channels per 125 microsecond time frame for synchronization, online testing and further routine tests. Here, the 8 bits of each data useful channel to be switched are expanded with 2 parity bits. In this way, falsifications in the data stream of the switching network can be detected and localized without the influence of the control in the switching system (cross office check). In particular when using a 184.32 Mbit/s signal, a sufficient basis is thus available for all monitoring and testing scenarios in the switching network.

In addition, owing to the concentration by the concentrator device, the number of cables to be laid (switching network lines) is reduced, for example, to 1/16 with respect to the input lines EL (with 8.192 Mbit/s).

In order to reduce further the amount of space required, the switching matrices or partial switching matrices described above are preferably embodied as ASICS.

1. A nonblocking switching network, having an input/output stage which has a multiplicity of input/output terminals (LIn) for connecting a multiplicity of line trunk groups (LTG) for a multiplicity of data channels (B0) to be switched; and a time/space switching network (RKN) for chronologically/spatially assigning the data channels (B0) to be switched among the multiplicity of input/output terminals (LIn) in a time-division multiplex system,
characterized in that the input/output stage has a concentrator network/demultiplexer network (KN) with a concentrator/demultiplexer device (KT) which compresses/distributes the multiplicity of data channels (B0) to be switched among switching network lines (KL) in the switching network, and
the time/space switching network (ZRKN) couples the data channels (B0) compressed on the switching network lines (KL) by means of at least one n/n switching matrix (KM), where n=1, 2, 3 . . . .

2. The nonblocking switching network as claimed in patent claim 1, characterized in that the concentrator network/demultiplexer network (KN) is composed of 0.5×n concentrator units/demultiplexer units (KE0 . . . 7) with respective input/output terminals (LI0 . . . 15), and the time/space switching network (ZRKN) has an n/n switching matrix (KM) in which only half of the switching points are used and actuated.

3. The nonblocking switching network as claimed in patent claim 1, characterized in that the concentrator network/demultiplexer network (KN) is composed of n concentrator units/demultiplexer units (KE0 . . . 15) with respective input/output terminals (LI0 . . . 15), and the time/space switching network (ZRKN) has two n/n switching matrices (KM) which are connected to one another, one switching matrix (KM1) being fixedly connected and the other switching matrix (KM0) being actuated.

4. The nonblocking switching network as claimed in patent claim 1, characterized in that the concentrator network/demultiplexer network (KN) is composed of a×n concentrator units/demultiplexer units (KE0 . . . 127), where a≧3, with respective input/output terminals (LI0 . . . 15), and
the time/space switching network (ZRKN) has a n/n switching matrices (KM . . . 15) and an a×n/a×n special switching matrix (KMS) which are connected to one another, the a n/n switching matrices (KM0 . . . 15) each being fixedly connected, and only the a×n/a×n special switching matrix (KMS) being actuated.

5. The nonblocking switching network as claimed in one of patent claims 1 to 4, characterized in that the switching network lines (KL) for connecting the respective switching matrices (KMa, KMS) to one another and/or to the concentrator/demultiplexer network (KN) represent optical and/or electrical interfaces.

6. The nonblocking switching network as claimed in one of patent claims 1 to 5, characterized in that the concentrator/demultiplexer device (KT) has a channel multiplexer unit/demultiplexer unit (KA) for compressing/distributing a multiplicity of data channels (B0) present in a multiplicity of input lines (EL), among the switching network lines (KL).

7. The nonblocking switching network as claimed in patent claim 6, characterized in that the channel multiplexer unit/demultiplexer unit (KA) adds/removes intra-channel protection data (KÜD) to/from the multiplicity of data channels (B0/B1).

8. The nonblocking switching network as claimed in patent claim 7, characterized in that the intra-channel protection data (KÜD) has synchronization data.

9. The nonblocking switching network as claimed in patent claim 7 or 8, characterized in that the intra-channel protection data (KÜD) protects and/or monitors a series of data channels (B0, B1).

10. The nonblocking switching network as claimed in one of patent claims 1 to 9, characterized in that the concentrator/demultiplexer device (KT) has a channel-expanding/channel-minimizing unit (KE) for expanding/minimizing the multiplicity of data channels (B0) into a multiplicity of expanded data channels (B1) with channel-specific protection data (KID).

11. The nonblocking switching network as claimed in patent claim 10, characterized in that the channel-specific protection data (KID) has synchronization data.

12. The nonblocking switching network as claimed in patent claim 10 or 11, characterized in that the channel-specific protection data (KID) protects and/or monitors each individual data channel (B0, B1).
